(19) United States
(12) Patent Application Publication
(10) Pub. No.: US 2015/0326174 A1
(43) Pub. Date: Nov. 12, 2015

(54) CLEANING DEVICE

(71) Applicant: SHARP KABUSHIKI KAISHA, Osaka-shi, Osaka (JP)

(72) Inventors: Ryoji ISHIMURA, Osaka-shi (JP); Hideaki NAGURA, Osaka-shi (JP); Makoto HORIYAMA, Osaka-shi (JP); Yasuhiro SAKAMOTO, Osaka-shi (JP)

(73) Assignee: Sharp Kabushiki Kaisha, Osaka-shi, Osaka (JP)

(21) Appl. No.: 14/651,762

(22) PCT Filed: Dec. 5, 2013
(86) PCT No.: PCT/JP2013/082721

§ 371 Date: Jun. 12, 2015

(30) Foreign Application Priority Data
Dec. 21, 2012 (JP) 2012-279453
Dec. 21, 2012 (JP) 2012-279454

(51) Int. Cl. H02S 40/10; B08B 3/02; B08B 1/00

(52) U.S. Cl. CPC H02S 40/10; B08B 1/006; B08B 3/02

(57) ABSTRACT

Provided is a cleaning device that does not cause degradation of cleaning performance even if there is an obstacle on a surface to be cleaned. A cleaning device includes a housing, blades used for cleaning, a cleaning liquid supply section for supplying cleaning liquid to a surface of a solar cell module, and a wheel for travelling on a solar photovoltaic power generation device. Moreover, the blades are arranged in such a manner that regions which pass through a fixation member are shifted and overlap each other in a front-rear direction with respect to an advancing direction.

### TECHNICAL FIELD

The present invention relates to a cleaning device that removes a foreign matter adhered to a surface to be cleaned, and particularly relates to a cleaning device that is suitable for cleaning of a light-receiving surface of a solar cell module.

### BACKGROUND ART

A general solar photovoltaic power generation device is configured by laying a plurality of solar cell modules side by side. In such a solar photovoltaic power generation device, each of the solar cell modules receives solar light to thereby generate power which is able to be utilized as a power source of various equipment, illumination or the like, for example.

A type and a structure of the solar cell modules used for the solar photovoltaic power generation device as described above vary and are not particularly limited. An example of the structure of the solar cell modules includes a structure in which a solar cell is supported in an electric insulating state and an electric floating state with a filler such as an EVA resin between a back surface cover and a toughened glass plate on a front surface that are put within a circumferential frame. Moreover, examples of the type of the solar cell modules include a crystalline silicon solar cell and a polycrystalline silicon solar cell. The solar photovoltaic power generation device is configured by laying single or a plurality of the solar cell modules having such various types and structures on a top surface of a roof or the like side by side.

In power generation by such solar cell modules, power generation efficiency changes according to light-receiving efficiency. Therefore, at the time of installing the solar cell modules, an inclination angle of the solar cell modules to an installation surface is adjusted so that the power generation efficiency becomes maximum. In such a solar photovoltaic power generation device, however, when rainwater is adhered to or dusts are accumulated on a light-receiving surface, they block solar light to reduce the light-receiving efficiency, so that power generation efficiency is degraded. In particular, in an area where a precipitation amount is small such as a desert/arid zone and an area where there are a lot of depositions of volcanic ashes, yellow sand, snow or the like, cleaning operation is performed because of necessity of cleaning dirt on a surface of a solar panel in order to generate power efficiently throughout the year.

In order to solve such a problem, PTL 1 describes a configuration of a light-receiving surface cleaning device that removes rainwater and dirt adhered to an entire surface of a light-receiving surface of a solar cell module with a wiping member. This light-receiving surface cleaning device adopts a configuration in which the wiping member provided so as to be movable on the solar cell module is slid on the light-receiving surface to thereby scrape off rainwater and dusts on the light-receiving surface. Further, this light-receiving surface cleaning device also allows cleaning the light-receiving surface in a dry period by supplying cleaning water to the light-receiving surface of the solar cell module.

A solar panel cleaner of PTL 2 is provided with gears on a frame of the solar panel cleaner and moves on the flame by electrically moving gear wheels, which are supported by fixed wheels, on the gears. Further, a cleaning mop or the like rotationally moves and cleans a solar panel by feeding and ejecting water from a cleaning hose.

In addition, a solar panel cleaning device described in PTL 3 self-propels quadrupedally on a solar panel and performs cleaning of the solar panel by a cleaning body (brush, blade) for cleaning a surface of the solar panel. Moreover, a high-pressure cleaning mechanism that ejects cleaning liquid at high pressure toward the surface of the solar panel is provided to raise dirt which is solidly stuck.

### CITATION LIST

### Patent Literature

PTL 1: Japanese Unexamined Patent Application Publication No. 2012-104787 (Publication date: May 31, 2012)

PTL 2: Japanese Unexamined Patent Application Publication No. 2010-287867 (Publication date: Dec. 24, 2010)

PTL 3: Japanese Unexamined Patent Application Publication No. 2010-186819 (Publication date: Aug. 26, 2010)

### SUMMARY OF INVENTION

### Technical Problem

Meanwhile, in a solar photovoltaic power generation device in which a plurality of solar cell modules are laid side by side, it is general to fix the solar cell modules by using respective fixation members. The fixation member is a member for fixing the solar cell modules on a pedestal (support member) which supports the solar cell modules, and fixes each of the solar cell modules at jointing parts (frame) of the adjacent solar cell modules. Moreover, the fixation member is provided on a side of a light-receiving surface of the solar cell module, and therefore projected with respect to the light-receiving surface. When such a fixation member is used, with the configuration described in PTL 1, since the wiping member has a width so as to make contact with each of the solar cell modules entirely in a width direction on the side of the light-receiving surface in the solar photovoltaic power generation device, the wiping member rides over the fixation member serving as a projection.

Thus, since the wiping member is not able to slide on the light-receiving surface around a site where the fixation member is arranged, rainwater, dusts and the like are not able to be removed sufficiently. Further, when cleaning water is supplied to the light-receiving surface, cleaning water which remains on the light-receiving surface near a frame around the fixation member in the solar cell module is also not able to be removed sufficiently.

The present invention has been made in view of the aforementioned problems and an object thereof is to provide a cleaning device capable of sufficiently cleaning a surface to be cleaned even when there is a projection on the surface to be cleaned.

### Solution to Problem

In order to solve the aforementioned problem, a cleaning device according to one aspect of the present invention includes a cleaning liquid supply section that supplies cleaning liquid to a surface to be cleaned, and a plurality of blades that wipe off the cleaning liquid that is supplied, and is characterized in that each of the blades is arranged so as to be shifted and positioned backward with respect to a same advancing direction of each of the blades, and adjacent blades are arranged so as to overlap each other in a partial region.

A cleaning device according to one aspect of the present invention includes a cleaning liquid supply section that supplies cleaning liquid to a surface to be cleaned, and a first blade that is an elastic member for wiping the surface to be cleaned, and is characterized in that the first blade is provided with a plurality of slits at a position corresponding to a convex portion that is protruded with respect to the surface to be cleaned and extends continuously along an advancing direction of the first blade.

### Advantageous Effects of Invention

According to one aspect of the present invention, it is possible to efficiently remove a foreign matter or cleaning liquid adhered to a surface to be cleaned of a solar cell module.

### BRIEF DESCRIPTION OF DRAWINGS

[FIG. 1](a) is a plan view showing a configuration of a solar photovoltaic power generation device to which cleaning devices of embodiments 1 to 3 of the present invention are applied commonly, (b) is a side view showing a state where the aforementioned solar photovoltaic power generation device is installed on an installation reference surface, and (c) is a cross-sectional view taken along a line A-A of (a);

[FIG. 2](a) is a plan view showing a configuration of the cleaning device according to one embodiment of the present invention, and (b) is a side view showing the configuration of this cleaning device;

[FIG. 3](a) is a plan view showing a state where the cleaning device of FIGS. 2(a) and (b) is installed in the aforementioned solar photovoltaic power generation device, and (b) is a side view showing a state where this cleaning device is installed in the aforementioned solar photovoltaic power generation device;

FIG. 4 is a plan view showing a configuration of a cleaning device according to another embodiment of the present invention;

FIG. 5 is a plan view showing a configuration of a cleaning device according to still another embodiment of the present invention;

FIG. 6 is a plan view and a side view explaining an installation state of the solar photovoltaic power generation device;

FIG. 7 is a plan view showing a schematic configuration of a cleaning device according to still another embodiment of the present invention;

FIG. 8 is a side view showing a schematic configuration of a cleaning device according to the still another embodiment of the present invention;

FIG. 9 is a perspective view showing a positional relation between blades of the cleaning device according to the still another embodiment of the present invention and solar cell modules;

FIG. 10 is a perspective view showing a positional relation between a blade of a cleaning device according to still another embodiment of the present invention and solar cell modules; and

FIG. 11 is a perspective view showing a positional relation between blades of a cleaning device according to still another embodiment of the present invention and solar cell modules.

### DESCRIPTION OF EMBODIMENTS

Description will hereinafter be given for a cleaning device according to one embodiment of the present invention with reference to drawings. In the following description of embodiments, same reference signs are assigned to same or corresponding parts in the drawings and description thereof will not be repeated. Note that, for convenience of description, expressions of upper, lower, left and right are used in the description of the embodiments, and these expressions are based on the drawings which are shown and not intended to limit the configuration of the invention.

Though description will be given for a solar panel cleaning device in the following embodiments, a form of the present invention is not limited to the solar panel cleaning device and may be any cleaning device as long as being utilized for a flat part such as a roof or a floor.

### Solar Photovoltaic Power Generation Device

FIG. 1(a) is a plan view showing a configuration of a solar photovoltaic power generation device 100, FIG. 1(b) is a side view showing a state where the solar photovoltaic power generation device 100 is installed on an installation reference surface G, and FIG. 1(c) is a cross-sectional view taken along a line A-A of FIG. 1(a).

The solar photovoltaic power generation device 100 includes a plurality of solar cell modules 101, pedestals 102 for holding the solar cell modules 101, and fixation members 103 for fixing the solar cell modules 101 and the pedestals 102.

As shown in FIG. 1(a), the solar cell module 101 has a circumference thereof protected by a frame 104. The solar photovoltaic power generation device 100 with a large area is configured by jointing the plurality of solar cell modules 101 in plural pieces. As shown in FIG. 1(c), in the solar cell module 101, the frame 104 is projected with respect to a panel surface 105 (light-receiving surface) of the solar cell module 101 in the cross-sectional view taken along the line A-A of FIG. 1(a). A projection amount of the frame 104 is about 3 mm from the panel surface 105.

As shown in FIG. 1(b), the solar cell modules 101 are placed on the plurality of pedestals 102 which are arranged at an interval on the installation reference surface G, and fixed to the pedestals 102 by the fixation members 103. The fixation member 103 is configured by a bolt 103a and a plate for fixation 103b. This fixation member 103 fastens the bolt 103a to the pedestal 102 in a state where the frame 104 of the adjacent solar cell module 101 is pressed by the plate 103b to thereby fix the solar cell module 101 to the pedestal 102. Therefore, the fixation member 103 is arranged so as to be projected from the frame 104. Moreover, the fixation member 103 has a different height (lengths) so that the solar cell modules 101 are installed being inclined from the installation reference surface G.

Note that, in the following description, when description will be given for the solar cell module 101 which is arranged at a high position from the installation reference surface G, this solar cell module 101 is referred to as an upper-side module 101A. Further, when description will be given for the solar cell module 101 which is arranged at a lower position than the upper-side module 101A, this solar cell module 101 is referred to as a lower-side module 101B.

Installation angles (inclination angles) and heights of the solar cell modules 101 with respect to the installation reference surface G are selected as appropriate according to installation states. The installation angles are set to around 10 degrees to 30 degrees in consideration of a power generation amount and the like.

### EMBODIMENT 1

Description will be given below for an embodiment 1 according to the present invention with reference to FIG. 2 and FIG. 3.

FIG. 2(a) is a plan view showing a configuration of a cleaning device 30 according to the present embodiment, and FIG. 2(b) is a side view showing the configuration of the cleaning device 30. FIG. 3(a) is a plan view showing a state where the cleaning device 30 is installed in the solar photovoltaic power generation device 100, and FIG. 3(b) is a side view showing a state where the cleaning device 30 is installed in the solar photovoltaic power generation device 100.

As shown in FIGS. 2(a) and (b), the cleaning device 30 includes a housing 1, blades 2, cleaning liquid supply sections 3, and wheels 4. As shown in FIG. 3(a), this cleaning device 30 is arranged on the two adjacent solar cell modules 101 (the upper-side module 101A and the lower-side module 101B). Moreover, the cleaning device 30 is arranged so that a longitudinal direction of the housing 1 which is formed in a rectangular parallelepiped as described below is matched with an arrangement direction of the two solar cell modules 101.

The housing 1 is used for fixing and holding the blades 2, the cleaning liquid supply sections 3 and the wheels 4. As shown in FIGS. 3(a) and (b), this housing 1 is formed in the rectangular parallelepiped which is slightly longer than a width of the solar photovoltaic power generation device 100 in a direction orthogonal to an advancing direction of the cleaning device 30 (rightward in the figures). Moreover, the housing 1 is desired to be configured by an aluminum frame or the like. When the housing 1 is configured by the aluminum frame, it is possible to make the cleaning device 30 lighter. This makes it possible to arrange even a large-sized cleaning device 30 in the solar photovoltaic power generation device 100 without exceeding a withstand load of the solar photovoltaic power generation device 100.

The blade 2 is formed in an elongated rectangle. Moreover, the blade 2 has an upper end edge portion fixed to a fixation section (not shown) provided in the housing 1. Moreover, a lower end edge portion of the blade 2 is exposed from a lower surface of the housing 1 so as to abut against the panel surface 105 of the solar cell module 101. Further, an end portion of the blade 2 on the frame 104 side makes contact with an inner wall of a projected part of the frame 104 with respect to the panel surface 105.

The blades 2 are provided in plural (here, four) pieces. Two of this blade 2 are assigned to each one solar cell module 101 as shown in FIG. 3(a). Moreover, the blades 2 are arranged so as to be inclined to the advancing direction of the cleaning device 30, that is, a same advancing direction of each of the blades 2. Specifically, the blades 2 are inclined in accordance with the solar cell module 101 which is inclined from the installation reference surface G, and are inclined so that an end portion positioned on an upper side of the blade 2 is positioned frontward with respect to the aforementioned advancing direction compared to an end portion positioned on a lower side thereof.

Note that, the blades 2 may not be necessarily inclined as described above, and may be arranged so that a longitudinal direction thereof is along the direction orthogonal to the aforementioned advancing direction.

The adjacent blades 2 in the same solar cell module 101 are arranged in such a manner that respective end portions which are proximate to each other overlap in a predetermined range (partial region) of regions 20a and 20b which pass through the fixation members 103 when the cleaning device 30 travels toward the advancing direction. Further, the adjacent blades 2 between the adjacent solar cell modules 101 are arranged in such a manner that respective end portions which are proximate to each other have a predetermined interval in a region 20c which passes through the fixation member 103 when the cleaning device 30 travels toward the advancing direction. This predetermined interval is a width which is a total of both joint sections 104d by which the two frames 104 of the adjacent solar cell modules 101 are jointed.

The blade 2 which is arranged on the upper side among the two blades 2 positioned on the upper-side module 101A is arranged on a front side of the blade 2 which is arranged on the lower side in the advancing direction of the cleaning device 30. Moreover, these blades 2 are arranged so as to be offset (shifted) at an interval of an offset distance Doff1 in an overlapping portion.

The blade 2 which is arranged on the upper side among the two blades 2 positioned on the lower-side module 101B is arranged on a front side of the blade 2 which is arranged on the lower side in the advancing direction of the cleaning device 30. Moreover, these blades 2 are arranged so as to be offset at an interval of an offset distance Doff2 in an overlapping portion.

The two blades 2 which are positioned on the upper-side module 101A are arranged on a front side of the two blades 2 which are positioned on the lower-side module 101B in the advancing direction of the cleaning device 30. Further, the adjacent blades 2 between the upper-side module 101A and the lower-side module 101B are arranged so as to be offset at an interval of an offset distance Doff3 in the region 20c.

In this manner, the blade 2 positioned on the upper side is arranged on a more frontward side in the advancing direction of the cleaning device 30.

Note that, the number of the blades 2 is not limited to four above, and is set according to the number of the fixation members 103. Moreover, a position where the blades 2 overlap is set according to an arrangement position of the fixation member 103.

The blades 2 are used for cleaning, and therefore desired to be of an elastic material. By forming the blades 2 of the elastic material, it is possible to keep adhesiveness between the blades 2 and the panel surface 105, and it becomes possible to remove water and a foreign matter such as dusts adhered onto the panel surface 105. As the elastic material, a rubber material such as EPDM (ethylene butadiene rubber) or NBR (nitrile rubber) is used. Moreover, cross-sectional shapes of the blades 2 are rectangular shapes with a uniform size, but may be tapered shapes that a side closer to the panel surface 105 becomes thin.

The cleaning liquid supply sections 3 are used for supplying cleaning liquid to a surface of the solar cell module 101 and each of the blades 2. Therefore, the plurality of cleaning liquid supply sections 3 are provided, and positioned frontward from the blades 2 in the advancing direction of the cleaning device 30 as well as arranged so as to be at a predetermined interval in a vicinity of the blades 2. This cleaning liquid supply section 3 may be configured by a nozzle for ejecting cleaning liquid at arbitrary position and region. Alternatively, the cleaning liquid supply section 3 may be an opening section which is formed in a pipe, a tube or the like. The cleaning liquid supply section 3 by the opening section does not use a nozzle or the like, thus making it possible to reduce cost of the cleaning device 30.

Note that, introducing of the cleaning liquid to the cleaning liquid supply sections 3 may be performed by water distributing pipes (not shown) connected to each of the cleaning liquid supply sections 3 or may be performed by storing in a tank (not shown) mounted in the cleaning device 30 once.

Moreover, the cleaning liquid may be liquid which includes a medical agent having a cleaning effect, or may be simply water.

By using a water distributing system as described above, it is possible to supply the cleaning liquid efficiently to the blades 2 and the solar cell modules 101. Therefore, the cleaning liquid used for cleaning the solar photovoltaic power generation device 100 is able to be saved, thus making it possible to reduce maintenance cost concerning cleaning.

The two wheels 4 are provided at each of both ends of the cleaning device 30 for the cleaning device 30 to travel on the solar cell modules 101. These wheels 4 are driven by a driving source such as a motor (not shown) and able to move on the solar cell modules 101 while rotating. Further, the wheels 4 may pass on any of the panel surfaces 105 and the frames 104 of the solar cell modules 101.

Subsequently, description will be given for cleaning operation of the solar photovoltaic power generation device 100 by the cleaning device 30 configured as described above.

At the time of cleaning, the cleaning device 30 drives the wheels 4 by the motor to thereby supply the cleaning liquid from the cleaning liquid supply sections 3 while traveling on the solar photovoltaic power generation device 100 in the advancing direction along a horizontal direction and wipes off the cleaning liquid flowing on the panel surface 105 serving as a surface to be cleaned with the blades 2.

The cleaning liquid supplied from the cleaning liquid supply sections 3 flows to a lower side along the blades 2 and is discharged to a lower end portion of the solar photovoltaic power generation device 100 from the blade 2 which is positioned on a lowermost side. This makes it possible to remove dusts or the like on the panel surface 105 with the cleaning liquid.

Moreover, as shown in FIGS. 3(a) and (b), the cleaning device 30 is arranged so as to step across the plurality of arranged solar cell modules 101 (the upper-side module 101A and the lower-side module 101B). This makes it possible to clean the solar cell modules 101 in a plurality of rows at the same time. Alternatively, the cleaning device 30 is also able to clean not the solar cell modules 101 in a plurality of rows but only the solar cell modules 101 in one row (for example, a row of the upper-side modules 101A or a row of the lower-side modules 101B). In this case, lengths of the housing 1 and the blades 2 may be set so as to correspond to a width of the solar cell modules 101 (length in the direction orthogonal to the advancing direction of the cleaning device 30).

As described above, in the solar photovoltaic power generation device 100, the fixation member 103 is configured by the bolt 103a and the plate 103b and therefore projected with respect to the panel surface 105 and the frame 104. Therefore, when a conventional single blade (wiping member) is used, this blade rides over the fixation member 103 so that a driving load on the motor becomes high. Accordingly, in order to maintain stable travelling of the cleaning device 30, it is desirable to increase a driving torque of the motor. However, in order to increase the driving torque of the motor, increase in a size and increase in cost of the motor are inevitable, which are therefore inconvenience for seeking to achieve reduction in the size and decrease in price of the cleaning device 30.

In order to avoid the inconvenience as described above, the cleaning device 30 of the present embodiment adopts a configuration in which the plurality of blades 2 are used so that the blades 2 overlap in the regions 20a and 20b of the fixation member 103, through which the cleaning device 30 passes. Such a configuration corresponds to a sort of dividing of the conventional single blade. Thereby, the blades 2 have overlapping end portions pushed away by the fixation member 103 when passing on the fixation member 103 as a projection, but do not ride over the fixation member 103 like the single blade. Therefore, the driving load on the motor does not become high as described above, so that it does not have to increase the driving torque of the motor. Accordingly, the cleaning device 30 is able to be configured without causing increase in the size and increase in cost of the motor.

Moreover, the adjacent blades 2 which are arranged on the same solar cell module 101 are arranged in front and back in the advancing direction of the cleaning device 30, and proximate end portions of both of the blades 2 overlap in the regions 20a and 20b. Thereby, the cleaning liquid flowing out from the end portion of the blade 2 on the front side is able to be received and wiped off by the blade 2 on the back side, and excellent wiping-off performance is able to be realized even in an overlapping portion.

Here, a range (width) where the end portions of the respective adjacent blades 2 overlap is preferably ensured to have a diameter of the bolt 103a (width of the projection) or more. Thereby, the both end portions which overlap are pushed away one by one by the fixation member 103 (mainly, bolt 103a). That is, after the end portion on the front side is pushed away, the end portion on the back side is pushed away. Therefore, a portion between the both end portions is not opened to a backward side in the advancing direction, so that the cleaning liquid is not let out backward. Accordingly, it becomes possible to ensure excellent wiping-off performance. On the other hand, when the aforementioned overlapping range is smaller than the diameter of the bolt 103a, the both end portions which overlap are pushed away by the fixation member 103 at the same time. Therefore, the portion between the both end portions is opened to the backward side in the advancing direction, so that the cleaning liquid flows out from this opened portion.

Meanwhile, as shown in FIG. 3(a), in the solar photovoltaic power generation device 100, the upper-side module 101A has the cleaning liquid accumulated in the joint section 104d of the frame 104, which is jointed with the lower-side module 101B, in some cases. Such accumulation of the cleaning liquid is caused because the frame 104 is projected from the panel surface 105 as described above and an end surface of the frame 104 is therefore higher than the panel surface 105. At the time of cleaning, the cleaning liquid, when being accumulated by a constant amount in a region which is formed by an inner wall of the joint section 104d and the panel surface 105, overflows and flows into the lower-side module 101B. However, only by simply flowing the cleaning liquid, a state where the cleaning liquid is accumulated by the constant amount is maintained.

Against this, in the cleaning device 30 of the present embodiment, the blade 2 which cleans the lower-side module 101B is arranged at a position which is offset from the blade 2 which cleans the upper-side module 101A in the region 20c. Thereby, the cleaning liquid which is accumulated in the joint section 104d is scraped off by the blade 2 which is positioned on the lower side of the upper-side module 101A and wiped off by the blade 2 which is positioned on the upper side of the lower-side module 101B. Accordingly, it is possible to solve the accumulation of the cleaning liquid in the joint section 104d.

The offset distance Doff3 described above is set in consideration of a time until the cleaning liquid overflows after starting to be accumulated, which is defined based on a travelling speed of the cleaning device 30 and an ejected amount of the cleaning liquid by the cleaning liquid supply sections 3. Moreover, the offset distance Doff3 may be set to a distance allowing wiping off the cleaning liquid which is discharged by a structure of discharging the cleaning liquid which is accumulated as described above forcibly. With such a configuration, it is possible to realize excellent wiping-off performance even in the solar photovoltaic power generation device 100 composed of the plurality of solar cell modules 101.

Note that, the offset distances Doff1 to Doff3 described above are desired to satisfy a relation of Doff≈Doff2<Doff3. When the offset distances Doff1 to Doff3 satisfy this relation, it is possible to realize excellent wiping-off performance as well as to reduce the size of the cleaning device 30. The reason thereof will be described below.

The offset distances Doff1 and Doff2 are set to the extent that the backward blade 2 is not pushed away by the projection according to a time t_off1 (≈t_off2) from when the blade 2 which is arranged frontward starts to make contact with the projection (fixation member 103) until abutting against the panel surface 105 of the solar cell module 101 after being pushed away by the projection. The offset distances Doff1 and Doff2 are represented like a formula (1) based on the aforementioned time t_off1 and a travelling speed v of the cleaning device 30.

Doff1≈Doff2≧t_off1×v (1)

When the offset distances Doff1 and Doff2 satisfy the formula (1), the cleaning liquid leaked from an end portion of the frontward blade 2 is able to be received and wiped off by the backward blade 2.

On the other hand, the offset distance Doff3 is set according to a time t_off3 until the cleaning liquid which is accumulated in the joint section 104d of the upper-side module 101A shown in FIG. 3 overflows and is transferred to the frame 104 and falls onto the panel surface 105 of the lower-side module 101B. The offset distance Doff3 is represented like a formula (2) based on the aforementioned time t_off1 and the travelling speed v of the cleaning device 30.

Doff3≧t_off3×v (2)

When the offset distance Doff3 satisfies the formula (2), the cleaning liquid leaked from an end portion of the frontward blade 2 is able to be received and wiped off by the backward blade 2.

Accordingly, it is a condition for meeting excellent wiping-off performance to satisfy the formula (1) and the formula (2).

Next, the cleaning liquid which is accumulated in the joint section 104d of the upper-side module 101A as describe above does not fall to the lower-side module 101B immediately, but is accumulated to some extent and flows down to the lower-side module 101B along the frame 104. Therefore, as represented by a formula (3), the time t_off3 for the cleaning liquid to flow down to the lower side at a site other than the projection becomes longer than the times t_off1 and t_off2 for the cleaning liquid to flow down to the lower side at a site of the projection.

t_off1≈t_off2≦t_off3 (3)

That is, the time for the cleaning liquid to flow down to the lower side becomes different between at the projection and the joint section 104d of the frame 104. Thus, a formula (4) is introduced by the formula (1) to the formula (3).

Doff1≈Doff2<Doff3 (4)

Satisfying the formula (1) and the formula (2) is enough only to realize excellent wiping-off performance. However, the formula (1) and the formula (2) allow setting an infinitely large offset distance, thus causing increase in the size of the cleaning device 30 (enlargement in a width direction of the cleaning device 30).

Against this, as represented in the formula (4), when a magnitude relation between the offset distances Doff1 and Doff2 and the offset distance Doff3 is determined in consideration of the time of flowing down of the cleaning liquid, it is possible to reduce the size of the cleaning device 30.

Incidentally, it is when the formula (1) and the formula (2) respectively represented by a formula (1)′ and a formula (2)′ as follows become minimum that the cleaning device 30 is able to be configured to be most minimized.

Doff1≈Doff2=t_off1×v (1)′

Doff3=t_off3×v (2)′

Moreover, though description has been given in the present embodiment for an example in which the cleaning device 30 moves in the advancing direction along the horizontal direction, the advancing direction of the cleaning device 30 is not limited thereto as long as the blade 2 is able to receive the cleaning liquid which flows out from the adjacent blade 2. For example, the cleaning device 30 may move in a direction heading from the upper side to the lower side, which is orthogonal to the aforementioned advancing direction.

### EMBODIMENT 2

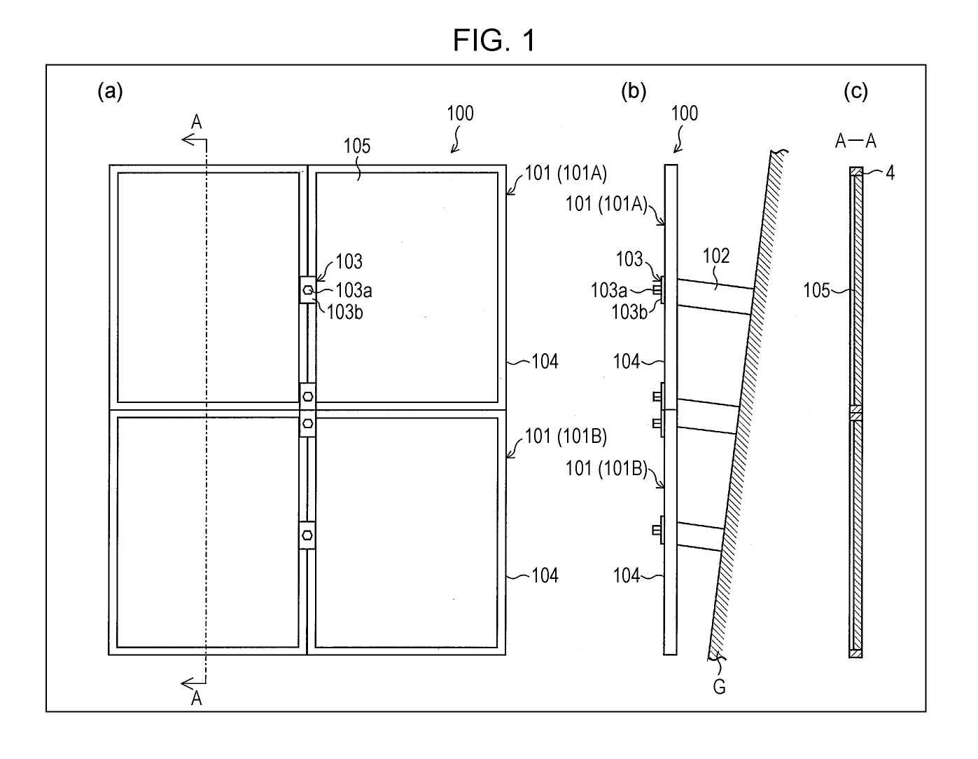

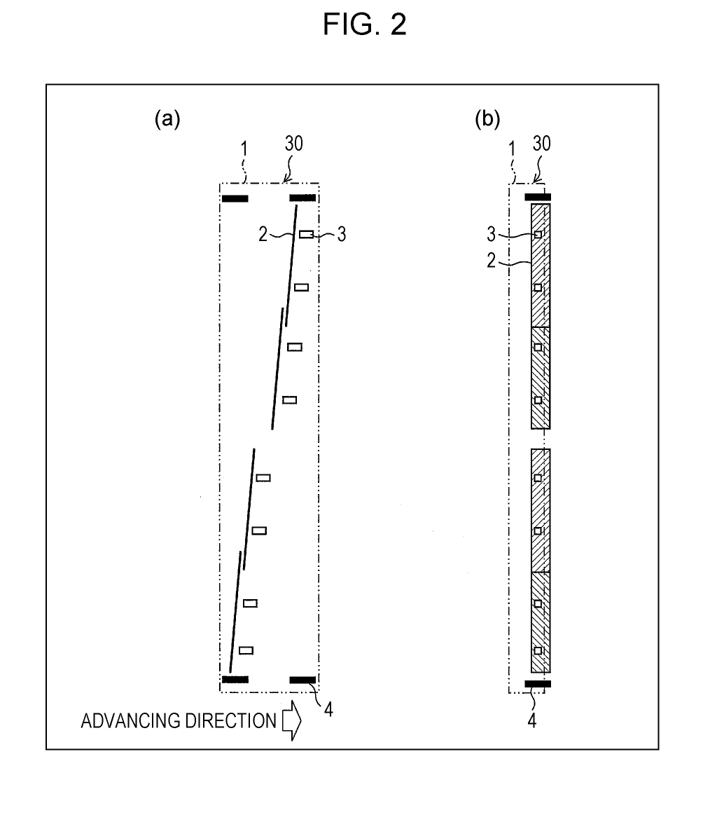

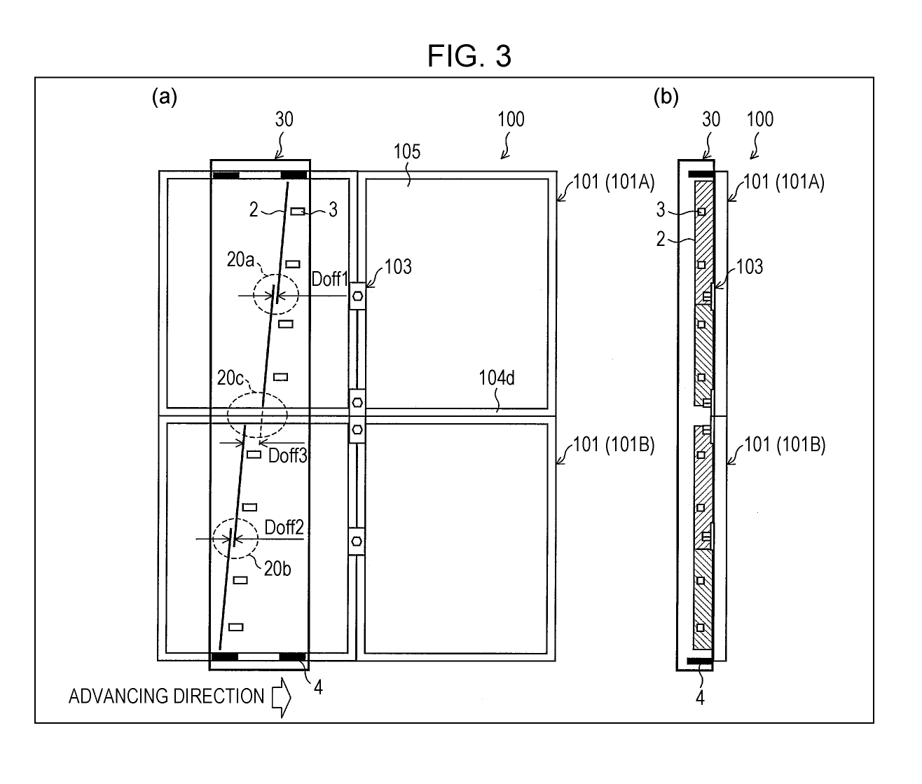

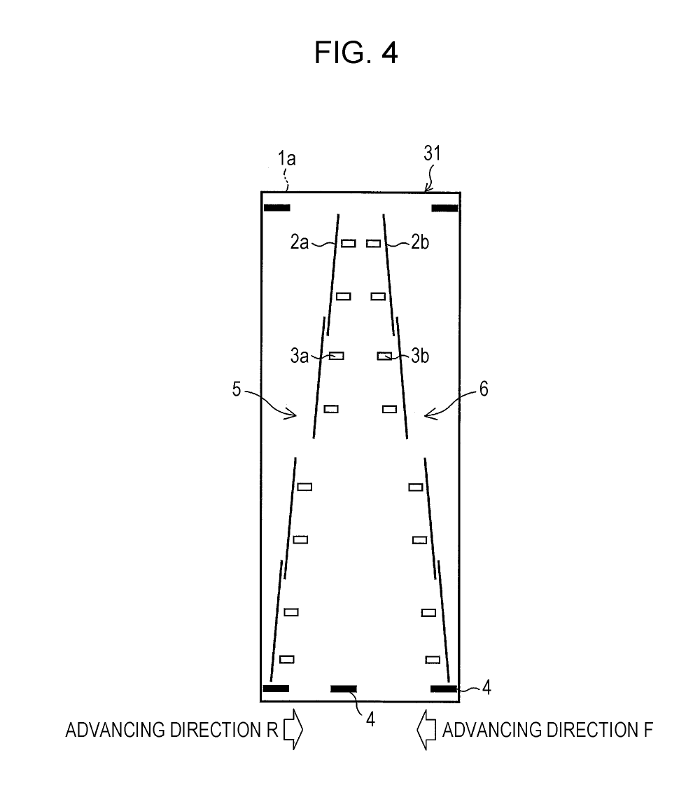

Description will be given below for an embodiment 2 according to the present invention with reference to FIG. 4.

Note that, in the present embodiment, same reference signs are assigned to components having equivalent functions to those of components in the embodiment 1 described above and description thereof will be omitted.

FIG. 4 is a plan view showing a configuration of a cleaning device 31 of the present embodiment.

As shown in FIG. 4, the cleaning device 31 includes a housing 1a, wheels 4 and cleaning mechanisms 5 and 6.

The housing 1a is configured in the same manner as the housing 1 in the cleaning device 30 described above except for a size. That is, the housing 1a contains the cleaning mechanisms 5 and 6, and is therefore formed to have a width along an advancing direction longer than that of the housing 1.

The cleaning mechanism 5 includes a plurality of (four, here) blades 2a and a plurality of cleaning liquid supply sections 3a. The cleaning mechanism 6 includes a plurality of (four, here) blades 2b and a plurality of cleaning liquid supply sections 3b.

The blades 2a and 2b are formed of the same material and in the same shape as those of the blades 2. Moreover, the blades 2a are arranged so as to be inclined to the advancing direction (advancing direction F in FIG. 4) as well as to be offset from each other in the same manner as the blades 2 in the cleaning device 30. Further, the blades 2a and 2b are arranged so as to face each other.

The blades 2b are arranged so as to be inclined to an advancing direction R (reverse direction to the advancing direction F) as well as to be offset from each other reversely to the blades 2a. Specifically, the inclination is made in such a manner that an end portion which is positioned on an upper side of the blade 2b is positioned frontward from an end portion which is positioned on a lower side in the aforementioned advancing direction R.

The offset distance between each of the blades 2a and the offset distance between each of the blades 2b are set to the offset distances Doff1 to Doff3 in the same manner as the blades 2.

The cleaning liquid supply sections 3a and 3b are respectively used for supplying cleaning liquid to surfaces (panel surfaces 105) of the solar cell modules 101 and each of the blades 2a and 2b. These cleaning liquid supply sections 3a and 3b are provided in plural pieces as well as are configured and arranged in the same manner as the cleaning liquid supply sections 3. Moreover, the cleaning liquid supply sections 3a and 3b are arranged so as to face each other.

The cleaning device 31 configured as describe above includes the cleaning mechanism 5 according to the advancing direction F and the cleaning mechanism 6 according to the advancing direction R. In other words, the cleaning device 31 includes two pairs of the blades 2a and 2b and the cleaning liquid supply sections 3a and 3b, which are arranged to face each other. Thereby, in the solar photovoltaic power generation device 100 that has long rows of the solar cell modules 101 in the advancing directions F and R, it is possible to clean the solar cell modules 101 while reciprocating on the rows of the solar cell modules 101. Therefore, even when dirt or the like is not able to be removed completely by cleaning in a forward passage, cleaning is performed again in a return passage, thus making it possible to further enhance cleaning capability.

Moreover, the solar photovoltaic power generation device 100 is configured by many rows of the solar cell modules 101 in some cases. In such a solar photovoltaic power generation device 100, when the cleaning device 31 reaches an end portion in one row of the solar cell modules 101 and finishes cleaning, the cleaning device 31 is moved to an end portion in the row of the solar cell modules 101, which is next to this row. This makes it possible to cause the cleaning device 31 to travel in an advancing direction which is reversed to an advancing direction in the row in which cleaning is finished in the next row. Accordingly, it becomes possible to clean the solar photovoltaic power generation device 100 having many rows of the solar cell modules 101 efficiently.

### EMBODIMENT 3

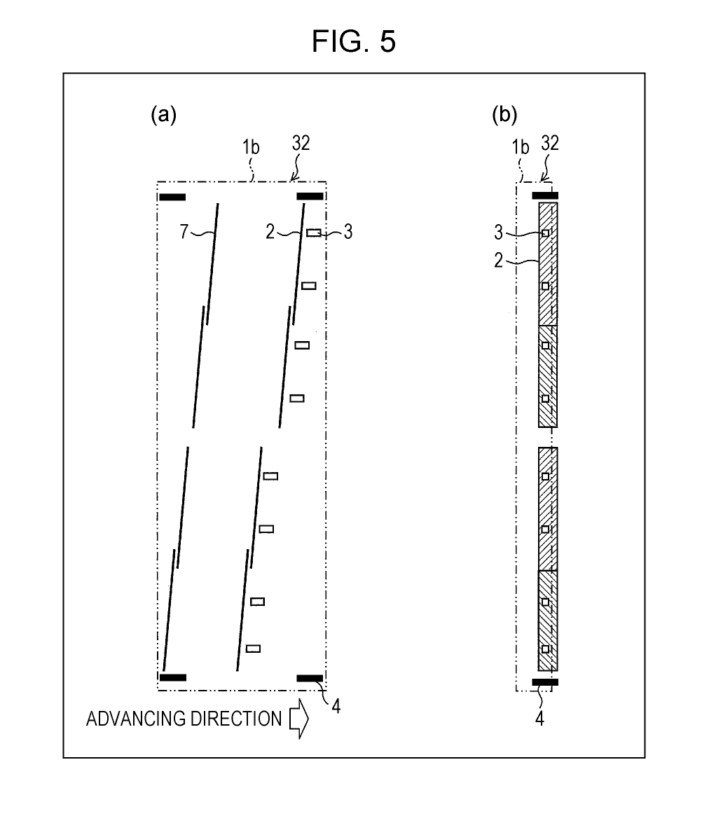

Description will be given below for an embodiment 3 according to the present invention with reference to FIG. 5.

Note that, in the present embodiment, same reference signs are assigned to components having equivalent functions to those of components in the embodiment 1 described above and description thereof will be omitted.

FIG. 5 is a plan view showing a configuration of a cleaning device 32 of the present embodiment.

As shown in FIG. 5, the cleaning device 32 includes a housing 1b, blades 2, cleaning liquid supply sections 3, wheels 4 and auxiliary blades 7.

The housing 1b is configured in the same manner as the housing 1 in the cleaning device 30 described above except for a size. That is, the housing 1b contains not only the blades 2 and the cleaning liquid supply sections 3 but the auxiliary blades 7, and is therefore formed to have a width along an advancing direction longer than that of the housing 1.

The auxiliary blades 7 are formed of the same material and in the same shape as those of the blades 2. Moreover, the blades 2a are arranged so as to be inclined to the advancing direction as well as to be offset from each other in the same manner as the blades 2 in the cleaning device 30. Further, the auxiliary blades 7 are arranged backward of the blades 2 in the advancing direction.

The cleaning device 32 configured as described above cleans the solar cell modules 101 by wiping off cleaning liquid supplied by the cleaning liquid supply sections 3 with the blades 2 in the same manner as the cleaning device 30. Moreover, the cleaning device 32 wipes off the cleaning liquid which is not wiped off completely by the blades 2 with the auxiliary blades 7.

In this manner, differently from the cleaning devices 30 and 31 described above, the cleaning device 32 includes the auxiliary blades 7 for wiping separately from the blades 2 for cleaning. This makes it possible to realize more excellent wiping-off performance.

Note that, the auxiliary blades 7 are desired to be configured in the same manner as the blades 2 as described above in order to facilitate manufacturing of the cleaning device 32. However, in the auxiliary blades 7, an overlapping amount, an inclination angle in the advancing direction, and the like may be different from those of the blades 2 according to cleaning conditions.

Further, the auxiliary blades 7 are applicable also to the cleaning device 31 described above. With such a configuration, the auxiliary blades 7 are arranged backward of the blades 2a in the advancing direction F as well as arranged backward of the blades 2b in the advancing direction R.

### EMBODIMENT 4

Description will be given in a following embodiment for a configuration in which a plurality of slits are provided at a position of a blade corresponding to a convex portion on a surface to be cleaned.

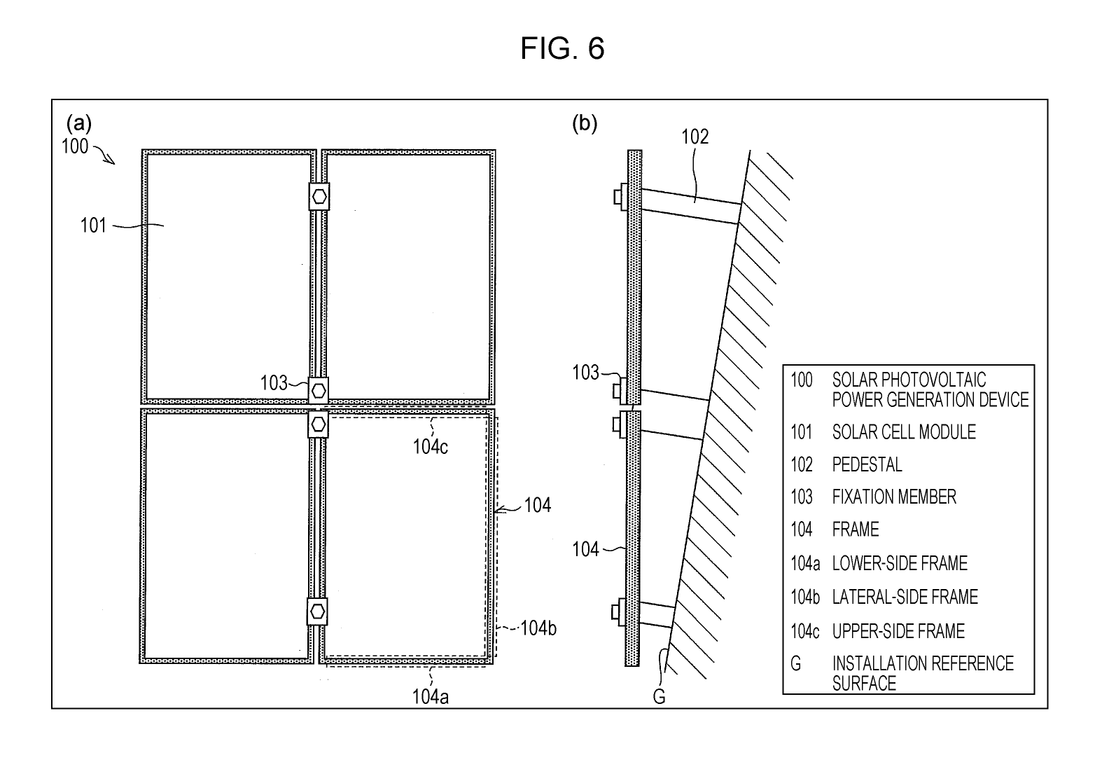

FIG. 6 is a view explaining an installation state of the solar photovoltaic power generation device 100. FIG. 6(a) is a front view of the solar photovoltaic power generation device 100, and FIG. 6(b) is a side view of the solar photovoltaic power generation device 100. The solar photovoltaic power generation device 100 is configured by solar cell modules 101, pedestals 102 for holding the solar cell modules 101, and fixation members 103. The fixation members 103 fix the solar cell modules 101 to the pedestals 102. A frame 104 for protecting circumference of the solar cell module 101 is provided in the solar cell module 101. Installation angles and heights of the solar cell modules 101 to an installation reference surface G are selected as appropriate according to an installation state. The installation angles are set to around 10 to 30° in consideration of a power generation amount and the like. The installation reference surface G itself may be inclined like a roof in some cases.

Moreover, there is a step between a light-receiving surface of the solar cell module 101 and the frame 104 for protecting the circumference. The frame 104 is projected from the light-receiving surface of the solar cell module 101 by about 3 mm. The light-receiving surface of the solar cell module 101 is a surface to be cleaned, which is cleaned by the cleaning device. Thereby, there is a problem that rainwater or liquid such as cleaning liquid adhered onto the solar cell module 101 is not able to go over the aforementioned step when going down along an inclined surface, and is accumulated in a vicinity of a lower-side frame 104a of the solar cell module 101.

Meanwhile, in the solar panel cleaner of PTL 2, the cleaning mop or the like rotationally moves and moves on the solar panel to perform cleaning by absorbing and ejecting water from the cleaning hose. However, a configuration only with the cleaning mop or the like has a problem that water after cleaning remains on the solar panel and therefore dirt in the air is likely to be adhered during a time before drying. Moreover, there is a problem that dirt such as sand dusts which has been deposited on the panel is mixed in the water after cleaning, so that this dirt is adhered again after drying and remains in a mottled pattern. In order to avoid this, it is also possible to flow off the dirt completely with plenty of water, but there is a problem that a usage amount of water and cost are increased. An area where the cleaning device for the solar panel is used is an area with poor water resource such as a desert/arid zone in many cases and reduction in the usage amount of water becomes a problem.

On the other hand, in the solar panel cleaning device of PTL 3, the brush is used to raise dirt and a blade is used to wipe off water (cleaning liquid) including the dirt on the panel. However, the solar panel generally has four sides covered with a frame for reinforcement, and in a cleaner of PTL 3, the blade does not deal with a convex shape of the surface of the solar panel by the frame, thus posing a problem that dirty water is left being unwiped in a vicinity of the frame.

### Configuration of cleaning device 10

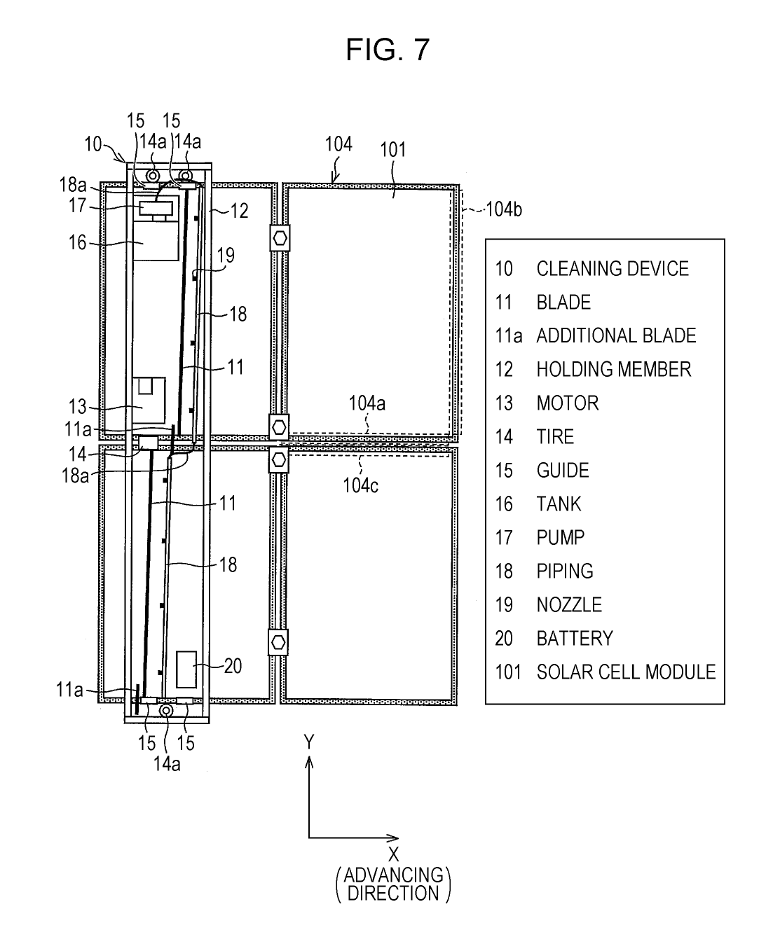

FIG. 7 is a plan view showing a schematic configuration of a cleaning device 10 according to the present embodiment. As shown in FIG. 7, the cleaning device 10 includes a plurality of blades 11 (second blades), a plurality of additional blades 11a (first blades), a holding member 12, a motor 13, tires 14 and 14a, guides 15, a tank 16, a pump 17, pipings 18 and tubes 18a. Moreover, an advancing direction of the cleaning device 10 is set as X and a direction which is in parallel to light-receiving surfaces of the solar cell modules 101 and orthogonal to the X direction is set as Y. The plurality of blades 11 and the plurality of additional blades 11a advance in the X direction with the cleaning device 10.

The cleaning device 10 is arranged at a position where the tire 14 makes contact on the frames 104 of the solar cell modules 101 as well as the guides 15 make contact with upper and lower ends of the solar cell modules 101. A distance between the solar cell module 101 and the cleaning device 10 is kept constant by the tire 14. Only one tire 14 is shown in FIG. 7, but a plurality of tires 14 may be arranged so as to make contact on the frame 104. Further, the guides 15 protect the cleaning device 10 from being detached or fallen from the solar cell modules 101 inclined from an installation reference surface as well as enhance stability when the cleaning device 10 advances linearly along the upper and lower ends of the solar cell modules 101. In addition, the plurality of tires 14a are arranged so as to make contact with the frames 104 in order to enhance stability of the cleaning device 10.

Directions in which the blades 11 and the additional blades 11a extend are desired to be slightly inclined to the direction Y perpendicular to the advancing direction of the cleaning device 10. In the present embodiment, the directions in which the blades 11 and the additional blades 11a extend are inclined to the direction Y by around 1 to 5°. Thereby, when the cleaning device 10 advances, a force for pushing out dirty water (liquid) on the solar cell module 101 to be wiped off by the blades 11 and the additional blades 11a to inclination directions of the blades 11 and the additional blades 11a works, so that the dirty water is able to be discharged smoothly from the light-receiving surface of the solar cell module 101. Moreover, by inclining the blades 11 slightly, the blades 11, when riding over a step of the frame 104 around the solar cell module 101, come to ride over it from a site abutted first gradually, thus making it possible to significantly reduce a load at the time of riding over. Note that, a reason why the inclination of the blades 11 has a slight amount of 1 to 5° is that as the inclination increases, a width of the holding member 12 in which the blades 11 are stored increases.

The additional blades 11a are attached at positions corresponding to each of the lower-side frames 104a of the solar cell modules 101 in order to wipe steps of the frames 104 around the solar cell modules 101, which are not able to be wiped sufficiently only by the blades 11. The lower-side frame 104a is a lower-side frame of two sides of the frame 104, which extend in the advancing direction of the cleaning device 10. An upper-side frame 104c is an upper-side frame of the two sides of the frame 104, which extend in the advancing direction of the cleaning device 10. Note that, in a state where the solar photovoltaic power generation device is actually installed, the lower-side frame 104a is a frame positioned on a lower side of the solar cell module 101. The lower-side frame 104a is a convex portion which extends continuously along the advancing direction of the cleaning device 10. Note that, frames of the two sides of the frame 104 that extend perpendicularly to the advancing direction of the cleaning device 10 are set as lateral-side frames 104b. The lower-side frame 104a, the lateral-side frames 104b and the upper-side frame 104c are projected with respect to the light-receiving surface of the solar cell module 101. A detailed positional relation of the additional blades 11a and the blades 11 will be described below.

Operation of the cleaning device 10 is performed when the motor 13 drives the tire 14. Though the present embodiment has a one-wheel driving form in which a rotational axis of the motor is directly coupled to the nearest tire 14, but may have two-wheel driving or four-wheel driving by transferring driving force of the motor to each tire with a shaft, a bearing, a timing belt and the like. The piping 18 is connected to the pump 17 by the tube 18a. Moreover, the piping 18 is connected to another piping 18 by the tube 18a. Further, a nozzle 19 for ejecting water (liquid) in a direction of the solar cell module 101 is attached to the piping 18, and at the same time with driving of the aforementioned motor 13, the pump 17 flows water accumulated in the tank 16 into the piping 18 to eject the water onto the solar cell module 101 through the aforementioned nozzle 19. Note that, the nozzle 19 is attached to the piping 18 in order to raise dirt on the solar cell module 101 by ejecting water vigorously in the present embodiment, but a hole may be made directly in the piping 18 to serve as an ejecting port. The piping 18 and the nozzle 19 (ejecting port) serve as a liquid supply section (cleaning liquid supply section) which supplies liquid (water) for cleaning to a surface to be cleaned.

Though the motor 13 and the pump 17 operate by power feeding from a battery 20 in the present embodiment, power may be fed directly to the motor 13 and the pump 17 by using an external power source. When power is fed directly to the motor 13 and the pump 17 from the external power source, a power source cord has to be wired from the cleaning device 10 to the external power source. In such a case, since the power source cord is likely to be caught by the solar cell module 101 and an obstacle therearound to impede driving of the cleaning device, it may be said that the battery is preferably mounted.

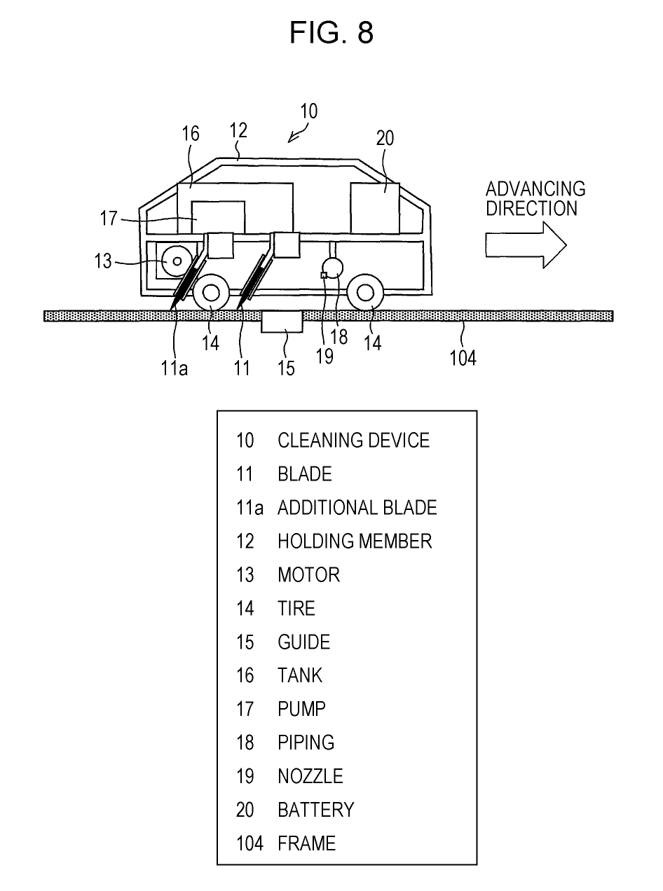

Description will be given below in more detail for various parts included in the cleaning device 10 according to the present embodiment. FIG. 8 is a side view showing a schematic configuration of the cleaning device 10 in the present embodiment.

The blade 11 and the additional blade 11a are arranged so that a front surface (light-receiving surface) of the solar cell module 101 and edges of the blade 11 and the additional blade 11a become in parallel. Moreover, the blade 11 and the additional blade 11a are fixed so as to be inclined by around 30 to 45° in the advancing direction of the cleaning device 10 from a normal line direction of a plane of the solar cell module 101. A reason why the blades are fixed so as to be inclined is to enhance wiping-off property for water used for cleaning of the solar cell module 101. As materials of the blade 11 and the additional blade 11a, materials having elasticity (elastic member) are preferably used in consideration of wiping-off performance for water and dirt and weathering resistance. For example, as the blade 11 and the additional blade 11a, rubber blades using EPT rubber, urethane rubber or the like are preferably used.

The piping 18 and the ejecting port such as a nozzle or a hole that is arranged in the piping 18 are arranged so that water is blown to the blade 11 or the solar cell module 101. Optimal values of the number of the ejecting ports and an ejecting amount are different depending on an advancing speed of the cleaning device 10 and a maximum pressure and a maximum flow rate of the pump, so that desired amounts may be calculated from performance of the motor 13 and the pump 17.

All components of the cleaning device 10 are fixed directly or indirectly to the holding member 12. The holding member 12 is preferably configured by a material which has excellent weathering resistance because the cleaning device 10 is used outdoors and further water is used to perform cleaning. Moreover, since the cleaning device 10 is installed so as to cover a longitudinal direction of the solar cell modules 101 which are arranged side by side and a size of the cleaning device itself becomes 3 m or more, the holding member 12 is desired to have high stiffness and a low weight. In the present embodiment, an aluminum member which is a metal member with light weight and having excellent anti-rust performance is used for the holding member 12 to provide a frame structure having excellent stiffness such as a truss structure, thus seeking lightweight.

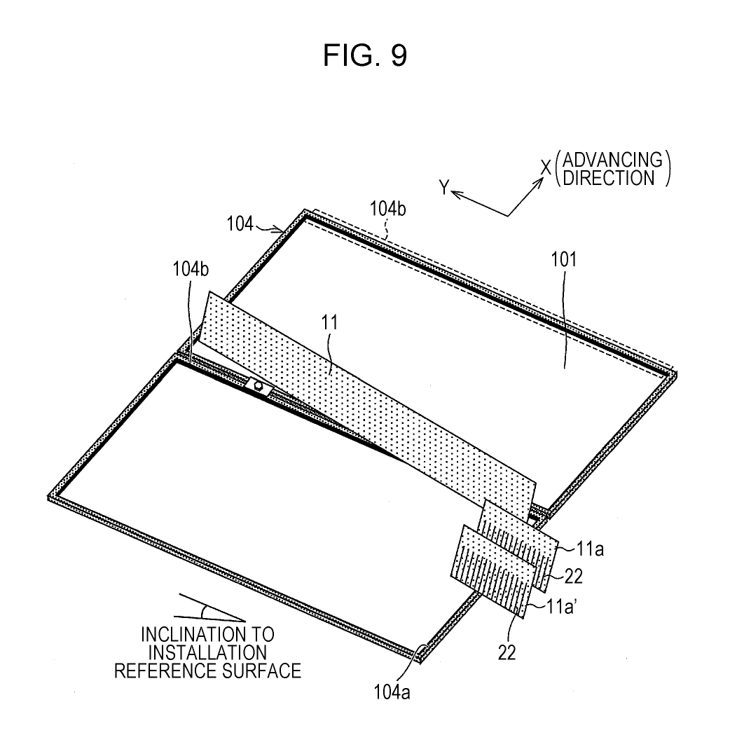

Description will be given below in more detail for the blades 11 and the additional blades 11a included in the cleaning device 10 according to the present embodiment. FIG. 9 is a perspective view illustrating only a positional relation between the blade 11 and the additional blade 11a and the solar cell modules 101 in the present embodiment.

As shown in FIG. 9, the blade 11 has a length that covers a whole between the upper-side frame and the lower-side frame of the solar cell modules 101 that are in parallel to the advancing direction of the cleaning device 10. However, it is difficult to remove all dirty water on the solar cell modules 101 by wiping only with the blade 11. A reason thereof includes a point that when water which is accumulated in a vicinity of the lower-side frame 104a of the solar cell module 101 overflows due to wiping of the blade 11, all thereof does not flow out from the lower-side frame 104a, but a part thereof comes around to an opposite side to an advancing direction of the blade 11. This is because C chamfering or R chamfering is applied for safety to the frames 104 of most of the solar cell modules 101, so that a part of dirty water which rides over the lower-side frame 104a once is returned to the light-receiving surface of the solar cell modules 101 through the aforementioned C-surface or an R portion (curved surface) again. To avoid this, a method is considered that the blade 11 is made equal to or longer than an interval between the frames 104 of the solar cell modules 101 and a position where the blade 11 makes contact with the lower-side frame 104a is cut out to have a shape same as a cross-sectional shape of the lower-side frame 104a. However, since the cleaning device 10 is a large device having a length of around 3 m in the longitudinal direction, the cut-out position of the blade 11 is difficult to be matched to a position of the lower-side frame 104a with high accuracy.

The additional blade 11a is a blade which is attached to deal with the aforementioned problem. The additional blade 11a has a plurality of slits 22 which reach the edge of the blade at a position at least corresponding to the lower-side frame 104a. The additional blade 11a having the slits 22 with a small pitch deforms according to a convex shape of the lower-side frame 104a and is able to wipe even a surface of the lower-side frame 104a in addition to the light-receiving surface, thus making it possible to discharge the accumulated dirty water efficiently. Moreover, differently from the aforementioned method for cutting out a part of the blade, it does not have to match the position closely and a structure is resistant to variation of the position.

In the present embodiment, by using an EPT rubber having thickness of 3 mm for the additional blade 11a and setting an interval of the slits 22 as about 3 mm and a depth of the slits as about 25 mm, it was confirmed that there is excellent discharge property. However, the depth and the interval of the slits 22 are able to be set according to a size of a step of the frame, magnitude of force with which the blade is pressed against the solar cell module in addition to the material and thickness of the blade.

The interval of the slits 22 may be made smaller than a width of the lower-side frame 104a with which the additional blade 11a makes contact. By making the interval of the slits 22 smaller than the width of the lower-side frame 104a, it is possible to make a space between the additional blade 11a and the solar cell module 101 smaller. Therefore, it is possible to discharge dirty water on the solar cell module 101 more efficiently. Further, a width of a region of the additional blade 11a where the slits are provided is larger than a width of a corresponding convex portion on the solar cell module 101.

Moreover, the number of the slits provided correspondingly to one convex portion (lower-side frame 104a) is also able to be set as three or more. In a case where the number of the slits is three or more, even when a position of the additional blade 11a is shifted, such arrangement is provided that any portion between the slits corresponds to the convex portion. Therefore, compared to a case where the number of the slits is two, it is possible to discharge dirty water more efficiently in a case where the number of the slits is three or more.

In addition, the plurality of slits 22 of the additional blade 11a are made in a direction perpendicular to the edge of the blade in the present embodiment, but may be made in an oblique direction so as to correspond to the cross-sectional shape of the frame 104.

Note that, when a relation between the position of the slits 22 of the additional blade 11a and the position of the lower-side frame 104a changes, wiping-off performance also changes. Thus, by arranging a backward additional blade 11a′ (fourth blade) having a shape same as that of the additional blade 11a in addition to the additional blade 11a, it is possible to improve wiping-off property easily. The backward additional blade 11a′ is arranged at a position corresponding to the lower-side frame 104a so as to be arrayed in an opposite direction to the advancing direction with respect to the additional blade 11a. In this manner, an additional blade may be added as appropriate according to desired cleaning performance.

Moreover, the additional blade 11a is preferably arranged at an interval on an opposite side to the advancing direction with respect to the main blade 11. Further, the blade 11 and the additional blade 11a are arranged so as to overlap partially in the advancing direction. This is for dealing with a phenomenon that a part of dirty water wiped off by the blade 11 remains as it is without riding over a step by the lateral-side frame 104b when a state becomes as shown in FIG. 9 in which the blade 11 rides over the lateral-side frame 104b between the solar cell modules 101. The dirty water which remains as it is without riding over the step goes down in an inclination direction from the installation reference surface of the solar cell module 101 along the lateral-side frame 104b with lapse of time and is finally accumulated in the vicinity of the lower-side frame 104a. By arranging the additional blade 11a at an interval on the opposite side to the advancing direction, it is possible to ensure time until dirty water which is left being unwiped by the preceding blade 11 is led to the vicinity of the lower-side frame 104a before the additional blade 11a reaches the lateral-side frame 104a. Since the dirty water which is accumulated in the vicinity of the lower-side frame 104a is then wiped off by the subsequent additional blade 11a, cleaning with excellent finish becomes possible. As a shift amount of the additional blade 11a (interval between the blade 11 and the additional blade 11a) increases, finish of cleaning becomes more excellent, but a lateral width of the cleaning device in which the blade 11 and the additional blade 11a are stored becomes wide accordingly. Therefore, the shift amount is able to be set according to the advancing speed of the cleaning device and the inclination angle of the solar cell module 101.

### EMBODIMENT 5

Description will be given below in detail for a cleaning device according to another embodiment of the present invention. Note that, components other than a blade of the cleaning device according to the present embodiment are same as those of the embodiment 4, so that description thereof will be omitted.

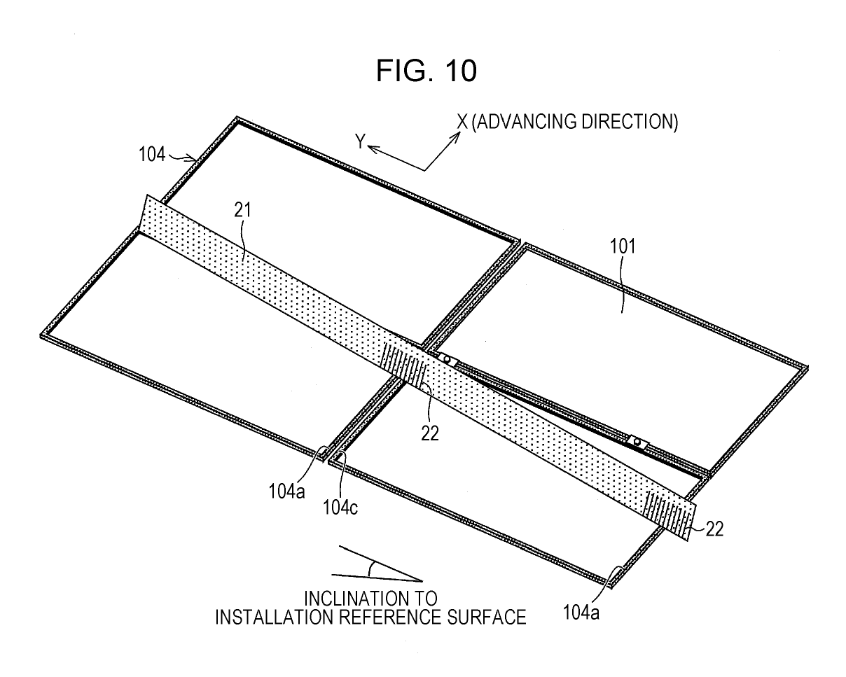

FIG. 10 is a perspective view illustrating only a positional relation between a blade 21 and the solar cell modules 101 in the present embodiment.

The cleaning device of the present embodiment includes the blade 21 (first blade) instead of the blade 11, the additional blade 11a and the backward additional blade 11a′ of the embodiment 4. The blade 21 has a length corresponding to from upper ends to lower ends of a plurality of solar cell modules 101 which are arrayed in a Y direction. The blade 21 has a plurality of slits 22 which reach an edge of the blade 21 at positions corresponding to the lower-side frames 104a and the upper-side frames 104c of the solar cell modules 101.

A width of a region where the slits 22 are provided in the blade 21 is wider than a width of convex portions (lower-side frames 104a and the upper-side frames 104) of the solar cell modules 101. Moreover, the blade 21 has a region having no slit 22 at positions corresponding to the light-receiving surfaces of the solar cell modules 101 (that is, positions not corresponding to the lower-side frames 104a and the upper-side frames 104). Therefore, it is possible to discharge dirty water on the flat light-receiving surfaces of the solar cell modules 101 appropriately.

The cleaning device of the present embodiment is able to wipe the plurality of solar cell modules 101 with one blade without having an additional blade. Therefore, it is possible to reduce the number of parts associated with the blade and realize cost reduction. Moreover, the cleaning device of the present embodiment does not have to shift an additional blade backward, thus making it possible to realize miniaturization and lightweight of the cleaning device. Therefore, the cleaning device of the present embodiment is economical compared to the cleaning device of the embodiment 4.

According to the cleaning device of the present embodiment, it is possible to meet needs including frequent cleaning by intruding a plurality of inexpensive cleaning devices.

### EMBODIMENT 6

Description will be given below in detail for a cleaning device according to still another embodiment of the present invention. Components other than blades of the cleaning device according to the present embodiment are same as those of the embodiment 4, so that description thereof will be omitted.

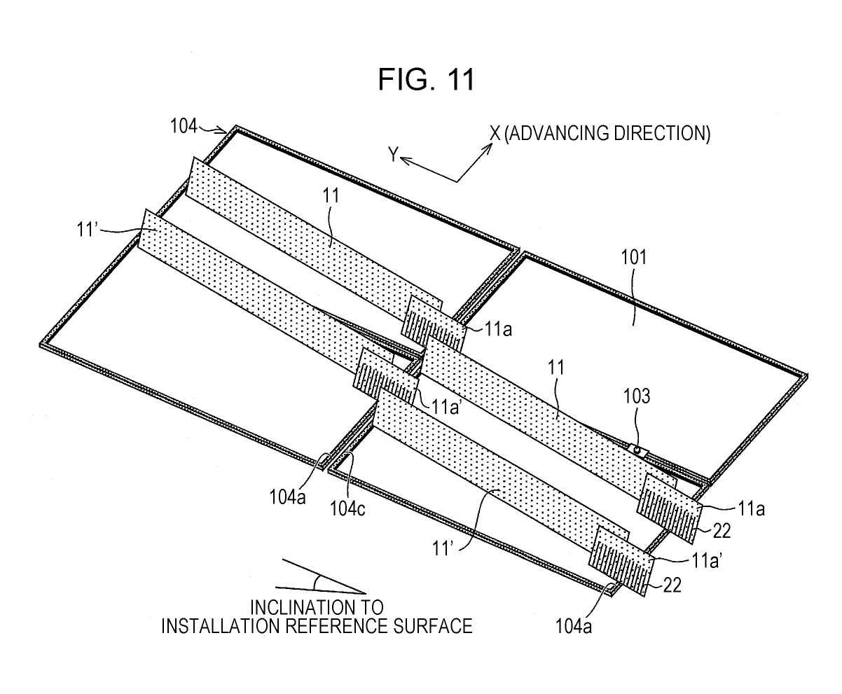

FIG. 11 is a perspective view illustrating only a positional relation between the blade 11, the additional blade 11a and the solar cell modules 101 in the present embodiment.

The cleaning device of the present embodiment includes backward blades 11′ (third blades) in addition to the blade 11, the additional blade 11a and the backward additional blade 11a′ of the embodiment 4. The backward blade 11′ is arranged at a position shifted to an opposite direction to the advancing direction of the cleaning device with respect to the blade 11. The backward additional blade 11a′ is arranged at a position shifted to the opposite direction to the advancing direction of the cleaning device with respect to the additional blade 11a, as well as on an opposite side to the backward blade 11′ in the advancing direction. The backward blade 11′ has a same configuration as that of the blade 11.

The backward blade 11′ is arranged at an interval on the opposite side to the advancing direction from the backward blade 11′. The backward additional blade 11a′ is arranged at an interval on the opposite side to the advancing direction from the backward blade 11′.

Thereby, dirty water which is left being unwiped by the preceding blade 11 and additional blade 11a is wiped off by the subsequent backward blade 11′ and backward additional blade 11a′, thus making it possible to provide the cleaning device which has excellent wiping-off performance.

Moreover, the cleaning device of the present embodiment is able to deal with wiping remnant associated with the fixation member 103 which fastens the frame 104 and the pedestal. The fixation member 103 is much more projected with respect to the light-receiving surface of the solar cell module 101 than with respect to the frame 104. A step between the light-receiving surface of the solar cell module 101 and the fixation member 103 is around 15 mm. For riding over this step by the blade 11, it is desirable to take measures such as intentionally loosening fixation of the blade 11 to a holding member of the cleaning device at a position corresponding to the fixation member 103. For this reason, linear wiping remnant is likely to be caused on a line which passes through the fixation member 103 and which is in parallel to the advancing direction of the cleaning device 10 on the solar cell module 101.

The backward blade 11′ is able to deal with the aforementioned linear wiping remnant which is not able to be dealt with by the additional blade 11a, thus making it possible to further enhance wiping-off performance compared to the embodiments 4 and 5.

### MODIFIED EXAMPLE

The additional blade 11a (and the backward additional blade 11a′) having the plurality of slits described in the embodiments 4 and 6 is also able to be provided in the cleaning devices 30 to 32 described in the embodiments 1 to 3. For example, the additional blade 11a is able to be arranged between two blades 2 which are adjacent between the upper-side module 101A and the lower-side module 101B (arranged at an interval of the offset distance Doff3).

### Cleaning System

A solar panel cleaning system includes any of the cleaning devices described above. Further, this solar panel cleaning system includes a residual quantity sensing function, an end portion sensing function, and/or a lifter/automatic guided vehicle, etc. The residual quantity sensing function is a sensing function of detecting a residual quantity of cleaning liquid in a tank to perform automatic stop and operation. The end portion sensing function is a sensing function of detecting an end portion of a row of solar panels (solar cell modules 101) to perform automatic stop. The lifter/automatic guided vehicle is a device for moving the cleaning device to a next row when many rows of solar panels exist. This solar panel cleaning system is a system which operates the cleaning device appropriately in accordance with a configuration of the solar photovoltaic power generation device 100 and which has flexibility capable of dealing with also a large-sized solar panel.

Therefore, there is an effect that it is possible to provide a cleaning system having high cleaning capability which is not affected by a convex shape of a surface to be cleaned.

Note that, the cleaning device described above is applicable suitably to a surface to be cleaned having a continuous convex portion along the advancing direction of the cleaning device without limitation to the solar photovoltaic power generation device. For example, it is also possible to adapt the cleaning device described above to an arcade having a curved surface, a general home roof, and a corridor.

### Overview

A cleaning device (cleaning device 30 to 32) according to an aspect 1 of the present invention includes a cleaning liquid supply section (cleaning liquid supply section 3) that supplies cleaning liquid to a surface to be cleaned (panel surface 105), and a plurality of blades (blades 2, 2a, 2b) that wipe off the cleaning liquid that is supplied, in which each of the blades is arranged so as to be shifted and positioned backward with respect to a same advancing direction of each of the blades and the blades that are adjacent are arranged so as to overlap in a partial region.

With the aforementioned configuration, it becomes possible that the cleaning liquid flowing out from the blade which is positioned on a front side with respect to the advancing direction is able to be received and wiped off by the blade which is positioned on a back side. This makes it possible to avoid that the cleaning liquid leaks backward of the blade with respect to the advancing direction. Therefore, it is possible to realize excellent wiping-off performance.

Moreover, by arranging the blades so as to pass through a projection in a part where the blades overlap, overlapping end portions are pushed away by the projection and do not ride over the projection. Therefore, since the part where the blades overlap is not opened to a backward side with respect to the advancing direction, the cleaning liquid is not let out backward. Accordingly, it becomes possible to ensure excellent wiping-off performance.

Thereby, such an effect is exerted that a foreign matter adhered to an entire surface of a light-receiving surface of the solar cell module is able to be removed without being left and cleaning liquid which remains in a frame of the solar cell module is also able to be removed together. Moreover, such an effect is also exerted together that it is possible to clean light-receiving surfaces of many solar cell modules at the same time.

A cleaning device according to an aspect 2 of the present invention may include a plurality of auxiliary blades that are arranged backward of all the blades with respect to the advancing direction, in which each of the auxiliary blades may be arranged so as to be shifted and positioned backward with respect to a same advancing direction of each of the auxiliary blades and adjacent auxiliary blades may be arranged so as to overlap in a partial region in the aforementioned aspect 1.

With the aforementioned configuration, even when cleaning liquid leaks from the blades, the auxiliary blades are able to wipe off the leaked cleaning liquid. Moreover, when the auxiliary blades are arranged in the same manner as the blades, a part where the auxiliary blades overlap is not opened to a backward side with respect to the advancing direction, so that the cleaning liquid is not let out backward. Accordingly, it is possible to improve cleaning capability of the cleaning device.

A cleaning device according to an aspect 3 of the present invention may be that there two sets of the cleaning liquid supply section and the blade are provided so as to perform cleaning in the advancing direction and in an opposite direction to the advancing direction, and the cleaning liquid supply section and the blade of each of the sets are arranged so as to respectively face each other in the aforementioned aspect 1 or 2.

With the aforementioned configuration, it is possible to perform cleaning in two ways. Thereby, when cleaning in one direction is insufficient, by performing cleaning in an opposite direction, it is possible to perform cleaning sufficiently. Accordingly, it is possible to further improve cleaning capability of the cleaning device.

A cleaning device according to an aspect 4 of the present invention may be that the blades are inclined with respect to the advancing direction in any of the aforementioned aspects 1 to 3.

With the aforementioned configuration, since the cleaning liquid flows along an inclination direction of the blades, it is possible to prompt discharging of the cleaning liquid.

A cleaning device according to an aspect 5 of the present invention may be that the surface to be cleaned is a light-receiving surface of a solar cell module, and the blades may be assigned to each row in a plurality of rows of solar cell modules in any of the aforementioned aspects 1 to 4.

With the aforementioned configuration, it is possible to clean the plurality of rows of the solar cell modules at the same time. Therefore, it is possible to enhance cleaning efficiency of a solar photovoltaic power generation device composed of the plurality of rows of the solar cell modules.

A cleaning device according to an aspect 6 of the present invention includes a cleaning liquid supply section (piping 18, nozzle 19) that supplies liquid for cleaning to a surface to be cleaned, and a first blade (11a) that is an elastic member for wiping the surface to be cleaned, in which the first blade is provided with a plurality of slits (22) at a position corresponding to a convex portion (lower-side frame 104a, upper-side frame 104c) which is protruded with respect to the surface to be cleaned and extends continuously along an advancing direction of the first blade.

With the aforementioned configuration, the first blade provided with the plurality of slits makes contact with the convex portion without a space in accordance with a shape of the convex portion on the surface to be cleaned. Thus, liquid which is likely to remain in a vicinity of the convex portion which extends continuously is able to be removed from the surface to be cleaned efficiently by the first blade having the plurality of slits. Therefore, it becomes possible to perform cleaning of the surface to be cleaned with less wiping remnant.

A cleaning device according to an aspect 7 of the present invention may be configured in the aspect 6 so that a second blade (11) that is an elastic member for wiping the surface to be cleaned is included, the second blade does not have a slit, and the first blade is arranged at an interval on an opposite side to an advancing direction of the first blade compared to the second blade.

With the aforementioned configuration, liquid which is left being unwiped by the preceding second blade is able to be wiped off by the first blade provided with the plurality of slits, which advances later. Therefore, it is possible to avoid wiping remnant even when another convex portion is at a position of the preceding second blade.

A cleaning device according to an aspect 8 of the present invention may be configured in the aspect 7 so that a third blade (11′) that is an elastic member for wiping the surface to be cleaned is included, the third blade does not have a slit, and the third blade is arranged at a position of being arrayed in an opposite direction to the second blade in the advancing direction of the first blade.

With the aforementioned configuration, liquid which is left being unwiped by the preceding second blade is able to be wiped off by the third blade which advances alongside in the advancing direction at a same position. Therefore, it is possible to avoid wiping remnant even when another convex portion is at a position of the preceding second blade.

A cleaning device according to an aspect 9 of the present invention may be configured in the aspects 6 to 8 so that a fourth blade (11a′) that is an elastic member for wiping the surface to be cleaned is included, the fourth blade is provided with a plurality of slits at a position corresponding to the convex portion that extends continuously, and the fourth blade is arranged at a position of being arrayed in an opposite direction to the first blade in the advancing direction of the first blade.

With the aforementioned configuration, the fourth blade is in accordance with a shape of the convex portion and the fourth blade provided with the plurality of slits makes contact with the convex portion without a space. Thus, liquid which is left being unwiped by the preceding first blade is able to be wiped off by the fourth blade having the plurality of slits, which advances alongside in the advancing direction at a same position. Therefore, it becomes possible to perform cleaning with much less wiping remnant.

A cleaning device according to an aspect 10 of the present invention may be configured in the aspects 6 to 9 so that the first blade has a first region where no slit is provided and the first region is not at a position corresponding to the convex portion that extends continuously but at a position corresponding to the surface to be cleaned.

With the aforementioned configuration, it is possible to wipe the surface to be cleaned and a circumference of the convex portion by the first blade. Therefore, it is possible to reduce the number of parts of the cleaning device and to perform efficient wiping.

A cleaning device according to an aspect 11 of the present invention may be configured in the aspects 6 to 10 so that an interval of the plurality of slits of the first blade is smaller than a width of the convex portion that extends continuously.

A cleaning device according to an aspect 12 of the present invention may be configured in the aspects 6 to 11 so that the first blade is provided with three or more of the slits.

A cleaning device according to an aspect 13 of the present invention may be configured in the aspects 6 to 12 so that the plurality of slits are perpendicular to an edge of the first blade and reach the edge of the first blade.

A cleaning device according to an aspect 14 of the present invention may be configured in the aspects 6 to 13 so that a width of a second region where the plurality of slits are provided in the first blade is larger than the width of the convex portion that extends continuously.

A cleaning device according to an aspect 15 of the present invention may be configured in the aspect 7 so that the second blade extends from one end to the other end of the surface to be cleaned, and the second blade is arranged at a position not corresponding to the convex portion that extends continuously.

Note that, the present embodiment is also able to be expressed as follows.

As to a cleaning device (cleaning device 30 to 32), in the cleaning device composed of a cleaning water supply section (cleaning liquid supply section 3) that supplies cleaning water to a glass surface (panel surface 105) and a blade section (blade 2) that wipes off the cleaning water that is supplied, the blade section is divided into a plurality of pieces and is composed of a preceding blade section that precedes with respect to an advancing direction of the cleaning device and a subsequent blade section that is arranged on a back side of the preceding blade.

Moreover, in the aforementioned cleaning device, the preceding blade section and the subsequent blade section are arranged to overlap in a partial region.

Moreover, in the aforementioned cleaning device, a second preceding blade section and a second subsequent blade section are arranged backward with respect to the advancing direction further from the preceding blade section and the subsequent blade section

Moreover, in the aforementioned cleaning device, the cleaning water supply section that supplies the cleaning water to the glass surface and the blade section that wipes off the cleaning water that is supplied are arranged to face each other so as to allow cleaning forward and backward.

The present invention is not limited to each of the embodiments described above, various modifications are possible in the scope indicated in Claims, and an embodiment acquired by combining appropriately technical means each disclosed in a different embodiment is also included in the technical scope of the present invention. Further, by combining technical means each disclosed in each embodiment, a new technical feature is able to be formed.

### INDUSTRIAL APPLICABILITY

The present invention may be utilized for cleaning a light-receiving surface of a solar cell module in order to maintain power generation efficiency in an optimum state in a solar photovoltaic power generation device.

### REFERENCE SIGNS LIST

1 housing

1a housing

1b housing

2 blade

2a blade

2b blade

3 cleaning liquid supply section

3a cleaning liquid supply section

3b cleaning liquid supply section

4 wheel

7 auxiliary blade

10 cleaning device

11 blade (second blade)

11a additional blade (first blade)

11′ backward blade (third blade)

11a′ backward additional blade (fourth blade)

12 holding member

13 motor

14 tire

15 guide

16 tank

17 pump

18 piping (cleaning liquid supply section)

19 nozzle (cleaning liquid supply section)

20 battery

21 blade (first blade)

22 slit

30 cleaning device

31 cleaning device

32 cleaning device

100 solar photovoltaic power generation device

101 solar cell module

101A upper-side module

101B lower-side module

103 fixation member

104 frame

104a lower-side frame

104b lateral-side frame

104c upper-side frame

105 panel surface (surface to be cleaned)

1. A cleaning device, comprising:
a cleaning liquid supply section that supplies cleaning liquid to a surface to be cleaned, and
a plurality of blades that wipe off the cleaning liquid that is supplied, wherein
each of the blades is arranged so as to be shifted and positioned backward with respect to a same advancing direction of each of the blades, and
adjacent blades are arranged so as to overlap each other in a partial region.

2. The cleaning device according to claim 1, comprising
a plurality of auxiliary blades that are arranged backward of all the blades with respect to the advancing direction, wherein
each of the auxiliary blades is arranged so as to be shifted and positioned backward with respect to a same advancing direction of each of the auxiliary blades, and
adjacent auxiliary blades are arranged so as to overlap each other in a partial region.

3. The cleaning device according to claim 1, wherein
two sets of the cleaning liquid supply section and the blade are provided so as to perform cleaning in the advancing direction and in an opposite direction to the advancing direction, and
the cleaning liquid supply section and the blade of each of the sets are arranged so as to respectively face each other.

4. The cleaning device according to claim 1, wherein
the blades are inclined with respect to the advancing direction.

5. The cleaning device according to claim 1, wherein
the surface to be cleaned is a light-receiving surface of a solar cell module, and
the blades are assigned to each row in a plurality of rows of solar cell modules.

6. The cleaning device according to claim 1, wherein
a first blade that is an elastic member and a second blade that is an elastic member are included as the plurality of blades,
the first blade is provided with a plurality of slits at a position corresponding to a convex portion that is protruded with respect to the surface to be cleaned and that extends continuously along an advancing direction of the first blade,
the second blade does not have a slit, and
the first blade is arranged at an interval on an opposite side to the second blade in the advancing direction of the first blade.

7. The cleaning device according to claim 6, wherein
a third blade that is an elastic member for wiping the surface to be cleaned is included,
the third blade does not have a slit, and
the third blade is arranged at a position of being arrayed in an opposite direction to the second blade in the advancing direction of the first blade.

8. The cleaning device according to claim 1, wherein
a first blade that is an elastic member and a fourth blade that is an elastic member are included as the plurality of blades,
the first blade is provided with a plurality of slits at a position corresponding to a convex portion that is protruded with respect to the surface to be cleaned and extends continuously along an advancing direction of the first blade,
the fourth blade is provided with a plurality of slits at the position corresponding to the convex portion that extends continuously, and
the fourth blade is arranged at a position of being arrayed in an opposite direction to the first blade in the advancing direction of the first blade.

9. A cleaning device, comprising:
a cleaning liquid supply section that supplies cleaning liquid to a surface to be cleaned; and
a first blade that is an elastic member for wiping the surface to be cleaned, wherein
the first blade is provided with a plurality of slits at a position corresponding to a convex portion that is protruded with respect to the surface to be cleaned and extends continuously along an advancing direction of the first blade.

10. The cleaning device according to claim 9, wherein
the first blade has a first region where no slit is provided, and
the first region is not at the position corresponding to the convex portion that extends continuously but at a position corresponding to the surface to be cleaned.
